(19) United States
(12) Patent Application Publication
(10) Pub. No.: US 2003/0139984 A1
(43) Pub. Date: Jul. 24, 2003

(54) System and method for cashless and clerkless transactions

(76) Inventor: William G. Seigel, Wellington, FL (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/284,454

(22) Filed: Oct. 31, 2002

Related U.S. Application Data
(60) Provisional application No. 60/330,794, filed on Oct. 31, 2001.

(51) Int. Cl. G06F 17/60

(52) U.S. Cl. 705/28

(57) ABSTRACT

The present invention relates to a system and method for conducting cashless and clerkless transactions to purchase a wide range of merchandise. The cashless and clerkless transaction system can comprise four main functional components: a point of sale terminal, identification devices, databases and a network to connect the components. A cashless and clerkless transaction can be implemented by gathering product information, gathering personal information and capturing biometric information from the individual seeking to purchase a product. The captured biometric information can be compared with stored biometric information to confirm a consumer's identity. Assuming the consumer's identity is confirmed, a sales transaction is permitted and inventory and financial databases are updated accordingly. Similarly, the system may be used to confirm that a customer has purchased merchandise that the customer is carrying as the customer exits a store.

### RELATED APPLICATIONS

This application claims priority under 35 U.S.C. § 119(e) to U.S. Provisional Application Ser. No. 60/330,794 (the '794 Prov. App.), filed Oct. 31, 2001, which is incorporated herein by reference in its entirety.

### FIELD OF THE INVENTION

The present invention relates generally to the use of identification devices to authenticate individuals. More particularly, it relates to the use of an identification device to conduct a sales transaction without the use of cash or a sales clerk.

### BACKGROUND OF THE INVENTION

Retailers of consumer goods must continually seek to reduce operation costs. One of the ways that retailers have historically sought to reduce operation costs is to lower labor costs by either reducing the number of sales clerks in a store or more efficiently processing sales transactions. Often reducing sales clerks is ill-received by consumers because it leads to poor customer service and long lines to pay for merchandise. As a result, retailers often seek to find ways to expedite the check-out process. For example, one way retailers expedite the check-out process is using bar codes on goods to be purchased.

Another way that retailers, as well as credit card companies, seek to lower operation costs is to reduce fraudulent use of credit or debit cards. A primary method to reduce fraudulent use of a credit card is to require a purchaser to sign the credit card receipt and compare that signature with the signature on the back of the credit card. This method has several deficiencies. First, sales clerks do not consistently implement the method. Second, even when they do, the process of having a human compare two signatures is of limited value because people can sufficiently forge an individual's signature to the satisfaction of a sales clerk.

The use of biometrics provides an opportunity to reduce operation costs of retailers, reduce credit card fraud and reduce a consumer's time when purchasing goods by avoiding the necessity to wait in long lines to pay. Biometrics are a group of technologies that provide a high level of security. Fingerprint capture and recognition is an important biometric technology. Law enforcement, banking, voting, and other industries increasingly rely upon fingerprints as a biometric to recognize or verify identity. See, Biometrics Explained, v. 2.0, G. Roethenbaugh, International Computer Society Assn. Carlisle, Pa. 1998, pages 1-34 (incorporated herein by reference in its entirety). Generally, a biometric is a measurable, physical characteristic or personal behavior trait used to recognize the identity, or verify the claimed identity, of a person who has a biometric reference template (e.g., data that represents a biometric measurement) on file.

What is needed is a cashless and clerkless transaction system that securely automates the purchasing process by using biometric information to authenticate an individual's identity.

### BRIEF SUMMARY OF THE INVENTION

The present invention provides a system and method for implementing cashless and clerkless transactions. A cashless and clerkless transaction system can comprise four main functional components: a point of sale (POS) terminal, identification devices, databases and a network or networks to connect the components. The point of sale terminal serves as a central point in the system and controls interactions between the other components. The identification devices gather identification information about the customer seeking to purchase merchandise and about the merchandise to be purchased. The databases can include biometrics, inventory, credit card, product information and the like.

The identification devices can perform at least three basic functions. The first function is to read product identification codes that are affixed to an item for sale. The second function is to gather personal identification codes from individuals desiring to purchase an item. The personal identification codes may include passwords, social security numbers, credit card numbers, or some other form of personal identification code that is easily processed. The third function is to capture biometric information from an individual desiring to purchase an item. The biometric information may include a wide range of data including, for example, a fingerprint, a palmprint or a portion of these. Biometric information can be captured by a personal identification device, such as a piezoelectric identification device or a wireless biometric transceiver device. A cashless and clerkless transaction system can be implemented with any combination of devices from one to three or more to perform the necessary functions.

The method to implement a cashless and clerkless transaction comprises gathering product information, gathering personal information (e.g. a credit card number) and capturing biometric information from the individual seeking to purchase a product. The biometric information can be used to authenticate the identity of the individual.

The biometric information can be captured using a personal identification device that is either affixed to a point of sale terminal or a wireless handheld device that is easily transportable by a consumer. The biometric information that is captured during the purchasing process is compared to stored biometric data about the customer. After a match is confirmed between the stored biometric data and the captured biometric data, the sales transaction will be permitted.

In another embodiment, the point of sale terminal may be used to compare biometric data contained on a credit or smart card with biometric data captured during the purchasing process. Once again if a match exists between the captured and stored biometric data—thereby confirming the identity of the purchaser—the sales transaction will be confirmed. The cashless and clerkless transaction can also include updating inventory and financial clearinghouse databases to properly record the transaction. Additionally, the cashless and clerkless transaction process can also encompass steps to confirm that a customer has purchased merchandise that the customer is carrying when the customer exits a store.

The present invention can dramatically improve the efficiency of the sales process for consumer goods and reduce credit and debit card fraud. These improvements are achieved because, through the use of biometric information, a purchaser's identify can be uniquely confirmed. Unlike signatures, which are easily forged, biometric information, such as a fingerprint, is unique to an individual and can not be easily duplicated. Additionally, improvements are achieved by automating the entire biometrics-based sales transaction process.

Further embodiments, features, and advantages of the present invention as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a wireless transceiver biometric device according to an embodiment of the invention.

FIG. 2 illustrates a more detailed view of the wireless transceiver biometric device of FIG. 1.

FIG. 3 illustrates a piezoelectric identification device according to an embodiment of the invention.

FIG. 4 illustrates circuit components of an identification device according to an embodiment of the invention.

FIG. 5 illustrates a wireless transceiver biometric device according to an embodiment of the invention.

FIG. 6 illustrates example environments in which the wireless transceiver biometric device of FIG. 1 can be used to complete different types of transactions.

FIG. 7 illustrates a cashless and clerkless transaction system according to an embodiment of the invention.

FIG. 8 illustrates a method for conducting a cashless and clerkless transaction according to an embodiment of the invention.

FIG. 9 illustrates a method for conducting a cashless and clerkless transaction using biometric information stored on a credit or smart card according to an embodiment of the invention.

FIG. 10 illustrates a method for authenticating biometric information according to an embodiment of the invention.

FIG. 11 illustrates a method for confirming that merchandise has been purchased when a customer exits a store according to an embodiment of the invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### I. Overview of the Invention

The present invention relates to systems and methods for conducting cashless and clerkless transactions. A cashless and clerkless transaction system can comprise four main functional components: a point of sale terminal, identification devices, databases and a network or networks to connect the components. The identification devices can perform at least three basic functions. In particular, the identification devices are used to read product identification codes that would be affixed to an item for sale. The second function is to gather personal identification codes from individuals desiring to purchase an item. The third function is to capture biometric information from an individual desiring to purchase an item.

The method for implementing a cashless and clerkless transaction comprises gathering product information, gathering personal information (e.g. a credit card number) and capturing biometric information from the individual seeking to purchase a product. The biometric information is used to authenticate the identity of the individual. Biometric information that is captured during the purchasing process is compared to stored biometric data about the customer. After a match is confirmed between the stored biometric data and the captured biometric data the sales transaction will be permitted. The cashless and clerkless transaction process can also include updating inventory and financial clearinghouse databases to properly record the transaction. Additionally, the cashless and clerkless transaction process can also encompass steps to confirm that a customer has purchased merchandise that the customer is carrying when the customer exits a store.

The present invention relates generally to a piezoelectric identification device and applications thereof. More particularly, it relates to a piezoelectric device for obtaining biometric data or information, such as for a print, and using the obtained information to recognize and/or verify the identify of an individual. Print can be any type of print including, but not limited to, a print of all or part of one or more fingers, palms, toes, foot, hand, etc. A print can also be a rolled print, a flat print, or a slap print. The use of the term “data” or “information” throughout the specification can be representative of a biometric, a digital or other image of a biometric (e.g., a bitmap or other file), extracted digital or other information relating to the biometric, etc.

The use of the term “match” or “matching” can be defined as the process of comparing a biometric sample against a previously stored template and scoring the level of similarity. Then, an accept or reject decision can be made based upon whether this score exceeds a predetermined threshold. Matching can be performed by comparing a party's print to one or more stored prints to either (1) determine if there is a match against the party's alleged identity or (2) a match against any stored print when there is no alleged identity.

The use of the term “verify” or “verification” can be defined as a one-to-one process of comparing a submitted biometric sample against a biometric reference or template (e.g., data which represents a biometric measurement of an enrollee, used by a biometric system for comparison against subsequently submitted biometric samples) of a single enrollee whose identity is being claimed to determine whether the submitted biometric sample matches the enrollee's template.

The use of the term “identify” or “identification” can be defined as the one-to-many process of comparing a submitted biometric sample against all of the biometric reference templates on file to determine whether it matches any of the templates and, if so, the identity of the enrollee whose template was matched.

### II. Wireless Transceiver Biometric Devices

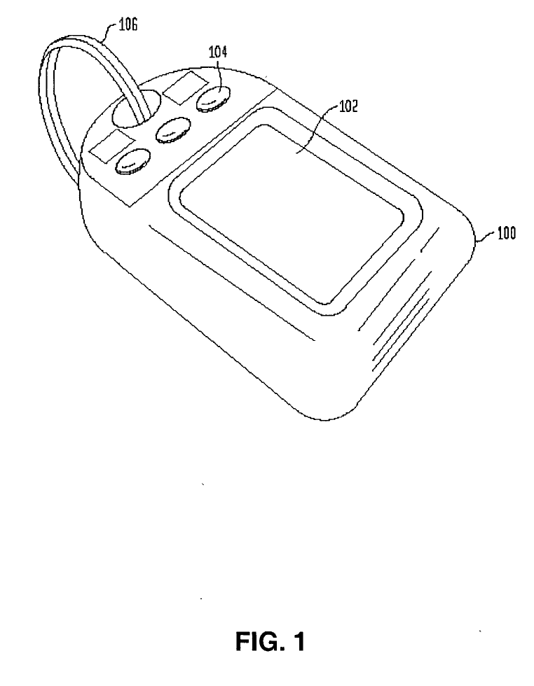

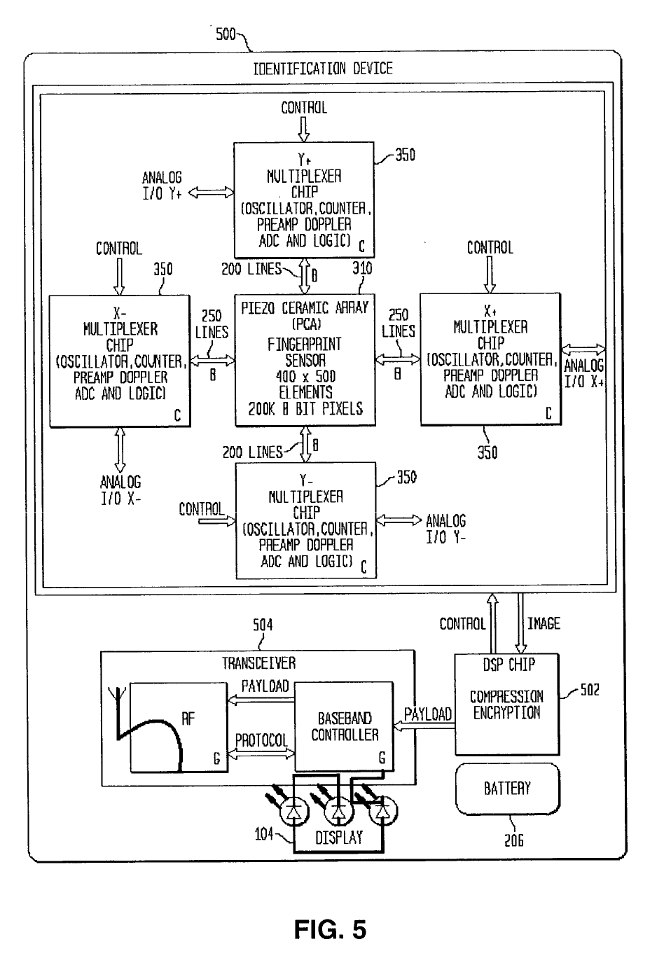

FIG. 1 illustrates a wireless transceiver biometric device 100 according to embodiments of the present invention. Device 100 is intended to be used by the general populace, for example, as an electronic signature device. Device 100 has a sensor 102 for obtaining biometric data (e.g., print data). In some embodiments, sensor 102 can be a piezo ceramic sensor or piezo electric thin film sensor. Device 100 can also have three indicator lights 104 for communicating information to a user. A key ring 106 can be attached to device 100. In same embodiments wireless transceiver biometric device 100 includes a BLUETOOTH wireless transceiver biometric device, as described further below with respect to FIG. 5.

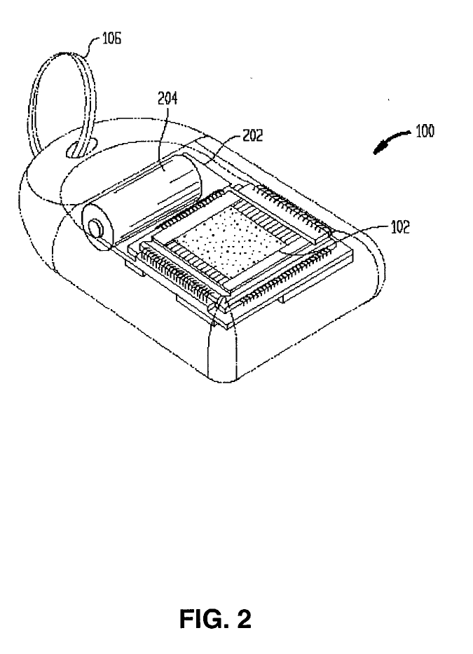

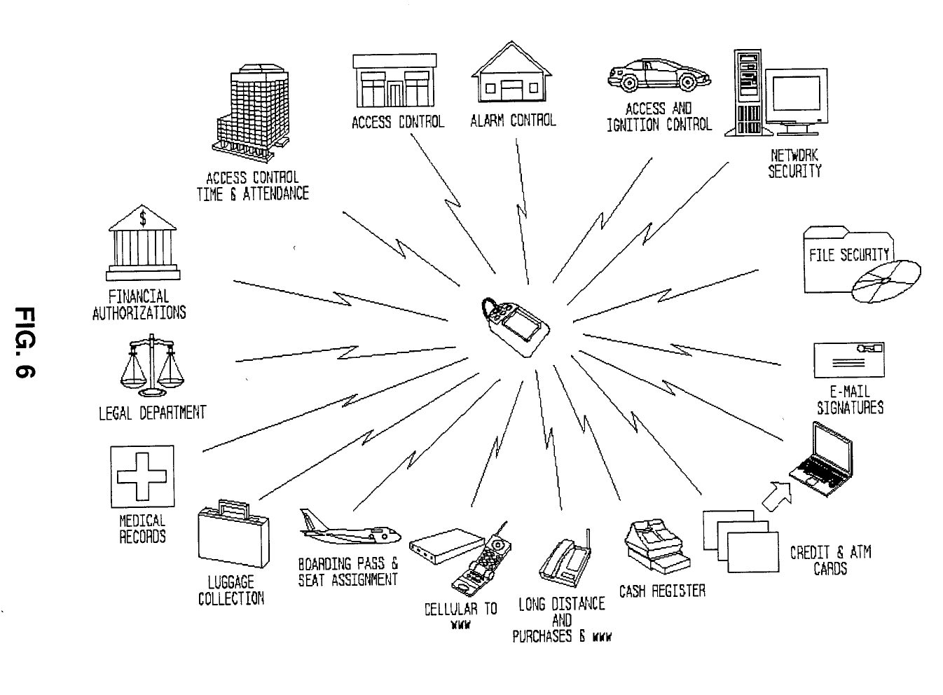

FIG. 2 illustrates a more detailed view of wireless transceiver biometric device 100 according to embodiments of the present invention. Device 100 has an antenna 202 that can be used for sending information to and receiving information from other devices. Sensor 102 is powered by a battery 204. In some embodiments, device 100 can be made to be compatible with BLUETOOTH wireless technology, as discussed above. Various uses of device 100 are described below in reference to FIGS. 6-9.

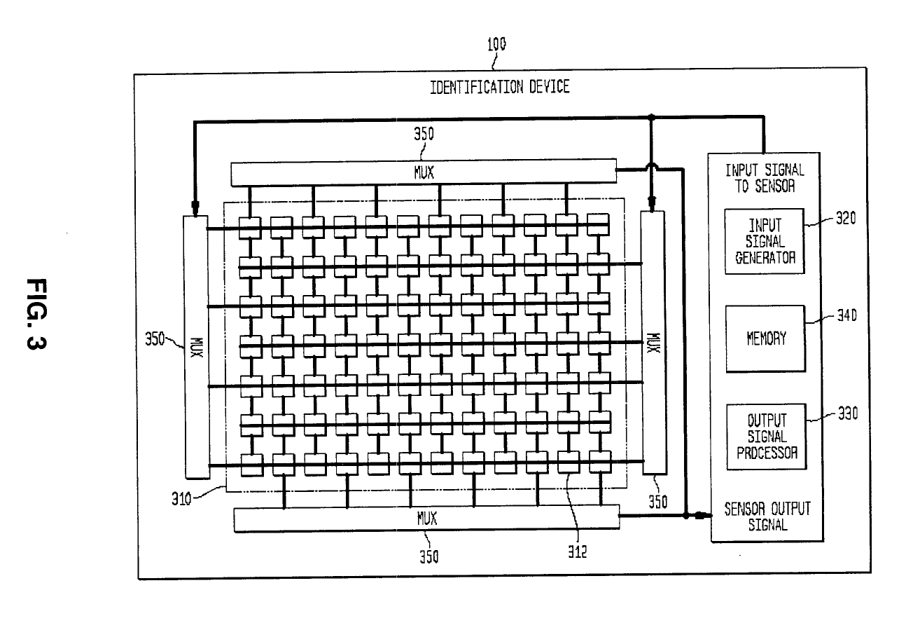

FIG. 3 is a schematic diagram of wireless transceiver biometric device 100 according to embodiments of the present invention. Identification device 100 has a piezoelectric sensor 310, a sensor input signal generator 320, a sensor output signal processor 330, and a memory 340. The input signal generated by input signal generator 320 is coupled to sensor 310 by two multiplexers 350. The output signal of sensor 310 is similarly coupled to output signal processor 330 by two multiplexers 350. In some embodiments, sensor 310 can be an array of piezo ceramic elements. In some embodiments, sensor 310 can include an array of polycrystalline ceramic elements that are chemically inert and immune to moisture and other atmospheric conditions. Polycrystalline ceramics can be manufactured to have specific desired physical, chemical, and/or piezoelectric characteristics. In other embodiments, sensor 310 can include a piezoelectric film (e.g., a polarized fluoropolymer film, such as polyvinylidene fluoride (PVDF) film or its copolymers can be used).

More detailed information on the elements and functions of the wireless transceiver biometric device can be found in the Ser. 60/330,794 Prov. App, which is incorporated by reference herein in its entirety.

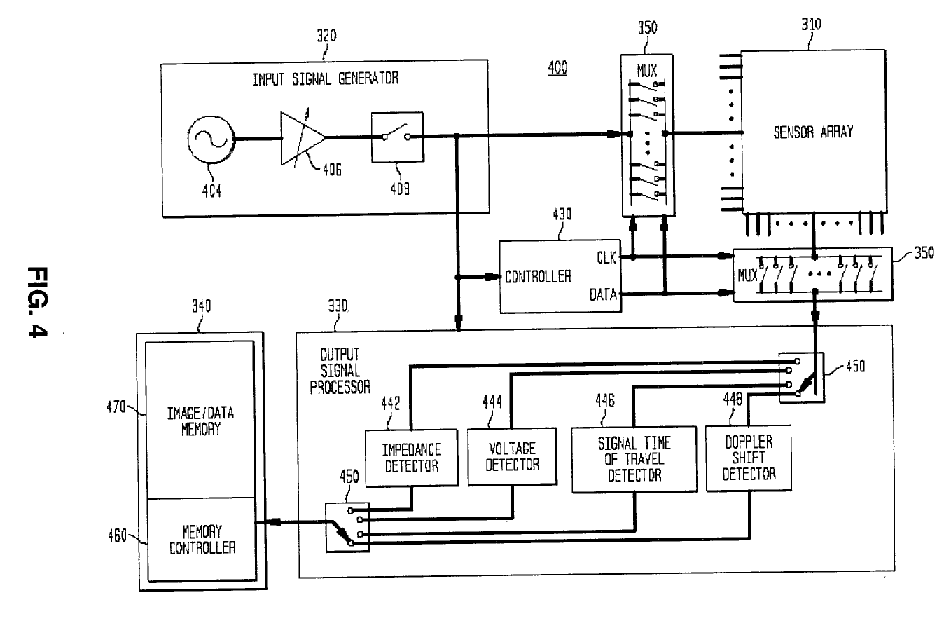

FIG. 4 illustrates an identification device 400 according to embodiments of the present invention. Device 400 includes an input signal generator 320, a sensor array 310, an output signal processor 330, a memory controller 460, and a memory 470. Sensor array 310 is coupled to input signal generator 320 and output signal processor 330 by multiplexers 350. A controller 430 controls the operation of multiplexers 350. The operation of identification device 400 is further described below.

In some embodiments, input signal generator 320 includes an input signal generator or oscillator 404, an variable amplifier 406, and a switch 408. In an embodiment, oscillator 404 produces a 20 MHz signal, which is amplified to either a low or a high voltage (e.g., about 4 volts or 8 volts) by variable amplifier 406, depending on the mode in which device 400 is operating. Switch 408 is used to provide either no input signal, a pulsed input signal, or a continuous wave input signal. Switch 408 is controlled to produce the various types of input signals described herein in a manner that would be known to a person skilled in the relevant art. The input signal generated by input signal generator 320 is provided to sensor array 310 via multiplexer 350, to controller 430, and to output signal processor 330. In an embodiment, sensor array 310 is a piezo ceramic composite of rectangular elements designed to operate with a 20 MHz input signal.

The output signal processor 330 includes various biometric detection devices, including an impedance detector 442, a voltage detector 444, a signal time of travel detector 446, and a doppler shift detector 448. Only one detector 442, 444, 446, or 448 is usually functioning during a period of time. Thus, switches 450 are used to coupled the functioning detector 442, 444, 446, or 448 to memory 340 and multiplexer 350. Further description of the operation of these detectors is found in U.S. Prov. App. Ser. 60/330,794, which is incorporated by reference herein in its entirety.

### III. Example Applications

A. Overview of Applications

In some embodiments, one wireless transceiver biometric device 100 or 400 (e.g., BLUETOOTH device 500 with a piezo ceramic sensor as discussed below) can wirelessly communicate to different types of devices (e.g., computer mice, physical access control units, telephones, palm devices, set top boxes, computers, ATM machines, keyboards, locks, ignitions, etc.) to provide additional biometric-based security so that only an authorized person can operate the respective devices or gain a desired access or authorization. For example, wireless transceiver biometric device 100 or 400 (e.g., BLUETOOTH device 500 with a piezo ceramic sensor) can communicate over a piconet to a telephone to provide additional security so that only an authorized person can operate the telephone. Similarly, wireless transceiver biometric device 100 or 400 can communicate to a remote control device to enhance security relating to the authorized use of set top boxes, televisions, recorders, players or other devices.

In other embodiments, a wireless transceiver biometric device 100 or 400 (e.g., BLUETOOTH device 500 with a piezo ceramic sensor) can be incorporated into any type of device where additional biometric security is desired. For example, wireless transceiver biometric device 100 or 400 can be incorporated in a telephone (not shown) to provide additional security so that only an authorized person can operate the telephone. Similarly, wireless transceiver biometric device 100 or 400 can be built in a remote control device (not shown) to enhance security relating to the authorized use of set top boxes, televisions, recorders, players, or other devices.

In still other embodiments, device 100 or 400 can be used for: building access control; law enforcement; electronic commerce; financial transaction security; tracking employee time and attendance; controlling access to legal, personnel, and/or medical records; transportation security; e-mail signatures; controlling use of credit cards and ATM cards; file security; computer network security; alarm control; and identification, recognition, and verification of individuals.

In still other embodiments, wireless transceiver biometric device 100 or 400 is a low-cost, ubiquitous device that identifies a person and records the signature through both the print image and biological features such as blood flow. Information is transmitted to the other person(s) engaged in a transaction via a BLUETOOTH wireless network with other devices in the BLUETOOTH networks, such as a controller, a processor or computer (e.g., palm device, PDA, laptop, desktop, server, etc.), a set top box, a cellular telephone, a land-line telephone, and/or a vehicle (e.g., an automobile). Wireless transceiver biometric device 100 or 400 transmits authorization functions for physical access and alarm control, ignition control, computer and network access control, e-mail signatures, credit card transactions, cell phone identification, airline transactions, financial enrollment transactions, etc. via BLUETOOTH piconets.

In still other embodiments, wireless transceiver biometric device 100 or 400 can include a piezo ceramic sensor used for applications within many market segments including, but not limited to, financial, physical access control, automotive, telecommunications, computers, law and order, health care, immigration, and welfare markets. For example, in one financial market segment application, wireless transceiver biometric device 100 or 400 is used for physical access control for bank employees, cardholder verification and secure transaction certification. As another example, in one physical access control market segment application, wireless transceiver biometric device 100 or 400 can be used for automotive access and theft control, garage door, house access and activation of domestic security systems. As a still further example, in one automotive market segment application, wireless transceiver biometric device 100 or 400 can be used as an access and ignition control device. As a still further example, in one computer market segment application, wireless transceiver biometric device 100 or 400 can interact in a biometric device for network access control.

In still other embodiments, in one telecommunications market segment application, wireless transceiver biometric device 100 or 400 can be incorporated in a telephone. A wireless telephone or land-line telephone incorporates at least a sensor array, such as, a piezo ceramic sensor array or piezo electric thin film sensor array according to embodiments of the present invention. Communication and digital signal processor (DSP) functions can be carried out by the other components in the telephone. In other embodiments, BLUETOOTH is incorporated into both cellular and fixed station telephones for proximal communications. The telephone is then a flexible portal that the consumer will use to assert biometric authorizations and/or identifications according embodiments of the present invention.

These are just a few of the many useful applications of device 100 or 400 in particular, and the present invention in general. Additional applications for device 100 or 400 and the invention will be apparent to those skilled in the relevant arts given the description of the invention herein.

B. Personal Area Network Applications

FIG. 5 illustrates a wireless transceiver biometric device 500 according to embodiments of the present invention. As described herein, embodiments of the invention are capable of interacting with other devices as part of a personal area network. Device 500 includes a biometric device (labeled as an identification device), which is similar to device 400, and which includes a DSP chip 502, a BLUETOOTH chip 504, a display (which can be similar to 104), and a battery 206. The identification device can have a piezo ceramic sensor array 310 and four multiplexers 350, according to embodiments of the invention. The identification device is coupled to DSP 502. DSP 502 controls the identification device and stores biometric data. DSP 502 is also coupled to BLUETOOTH chip 504 for sending and receiving data. The display is used to communicate information to a user of device 500. Device 500 is powered by battery 206.

As would be known to a person skilled in the relevant art, BLUETOOTH is an agreement that governs the protocols and hardware for a short-range wireless communications technology. The invention is not limited to implementing only the BLUETOOTH technology. Other wireless protocols and hardware can also be used.

With continuing reference to FIG. 5, device 500 allows an individual to be in communication with compatible devices within about 30 feet of device 500. Device 500 can connect, for example, with telephones, cell phones, personal computers, printers, gas pumps, cash registers, Automated teller machines, door locks, automobiles, set top boxes, etc (none shown). Device 500 is able to supply a standardized secure identification or authorization token to any device, or for any process or transaction that needs or requests it. This is because device 500 can connect to and exchange information or data with any compatible device within a personal area network or piconet.

C. Electronic Sales and/or Transaction Applications

FIG. 6 illustrates using the wireless transceiver biometric device (e.g., device 100, 400, and/or 500) to provide security and/or to complete various transactions, according to embodiments of the present invention. The transactions shown, which are not exhaustive, include: alarm control, access and ignition control of a vehicle, network security, file security, e-mail signatures, credit and ATM cards, a cash register, long distance and www purchases, cellular, boarding pass and seat assignments, luggage collection, medical records, legal records, finical records, time and attendance records, access control, or the like.

D. Cashless and Clerkless Transaction Systems

The wireless transceiver biometric devices described above may be used in a plethora of applications. One such application is a cashless and clerkless transaction system to enable consumers to purchase consumer goods, such as clothing, sporting equipment, or electronics without the use of cash or the assistance of a sales clerk.

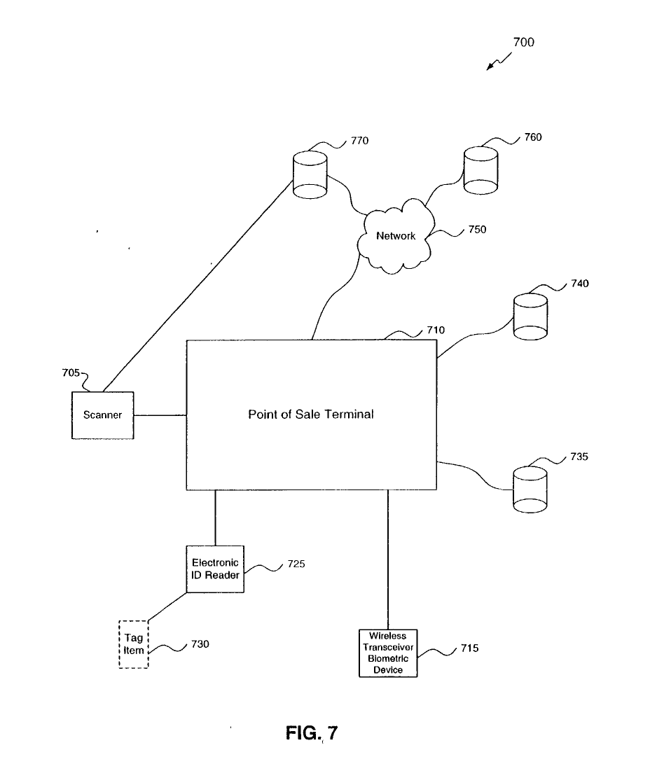

FIG. 7 illustrates a cashless and clerkless transaction system 700. A cashless and clerkless transaction system can comprise four main functional components: a point of sale terminal, identification devices, databases and a network or networks to connect the components. In one embodiment, cashless and clerkless transaction system 700 comprises point of sale terminal 710 and three identification devices: scanner 705, electronic identification reader 725 and wireless transceiver biometric device 715. Each device may be connected to point of sale terminal 710 with a physical connection or wirelessly. Cashless and clerkless transaction system 700 also comprises four databases: product information database 735, inventory database 740, credit card and billing information database 760 and biometrics database 770.

Point of sale terminal 710 can be connected to biometric database 770 and credit card and billing information database 760 through network 750. Network 750 may be any form of communications network using either wireline or wireless technology, provided that it is secure and reliable. Network 750 may be either public or private. Point of sale terminal 710 is coupled using either wireline or wireless technology directly to inventory database 740 and product description database 735. In an alternative embodiment, point of sale terminal 710 may be connected to inventory database 740 and product description database 735 through a network, similar to network 750.

The identification devices 705, 715, and 725 perform at least three basic functions. In particular, the identification devices can be used to read product identification codes, such as tag item 730, that would be affixed to an item for sale. The identification codes may be in the form of bar codes, electronic smart tags that transmit product information, or some other form of machine readable identification. In the embodiment shown, electronic identification reader 725 reads product identification codes. The second function of the identification devices is to gather personal identification codes from individuals desiring to purchase an item. The personal identification codes may include passwords, social security numbers, credit card numbers, or some other form of personal identification code that is easily processed. In the embodiment shown, any of the identification devices 705, 715, and 725 may perform this function by requiring the customer to provide the information.

The third function of the identification devices is to capture biometric information from an individual desiring to purchase an item. The biometric information may include a wide range of data including, for example, a fingerprint, a palmprint or a portion of these. Biometric information can be captured by a device that is either fixed to point of sale terminal 710, such as scanner 705 or through a device that is coupled wirelessly to point of sale terminal 710, such as wireless transceiver biometric device 715, which may be easily transported by an individual. In the embodiment shown, wireless transceiver biometric device 715 is a handheld personal identification device. Wireless transceiver biometric device 715 may be a piezoelectric identification device, wireless transceiver biometric device 100, 400 or 500, or some other form of identification device (e.g., devices using silicon capacitive sensor technology). While three personal identification devices are shown in the embodiment to conduct the functions of gathering biometric information, personal identification codes and product identification codes, a cashless and clerkless transaction system could be implemented with any combination of devices from one to three or more to perform the necessary functions.

The database systems contain information necessary to facilitate a cashless and clerkless transaction with a high degree of security. In particular, product description database 735 can contain product description and pricing information about items that may be purchased. Inventory database 740 can contain inventory information for a store that records when items are sold and maintains inventory information. Credit card and billing information database can contain information regarding personal identification code information and credit worthiness of individuals, can record credit or debit card transactions and can serve as a billing clearinghouse. Biometric database 770 can contain stored biometric print information for consumers that will be compared against prints that are taken at point of sale terminal 710 to verify the identity of an individual. While four databases are shown in the embodiment, a cashless and clerkless transaction system can be implemented with any combination of databases from one to four or more to perform the necessary functions.

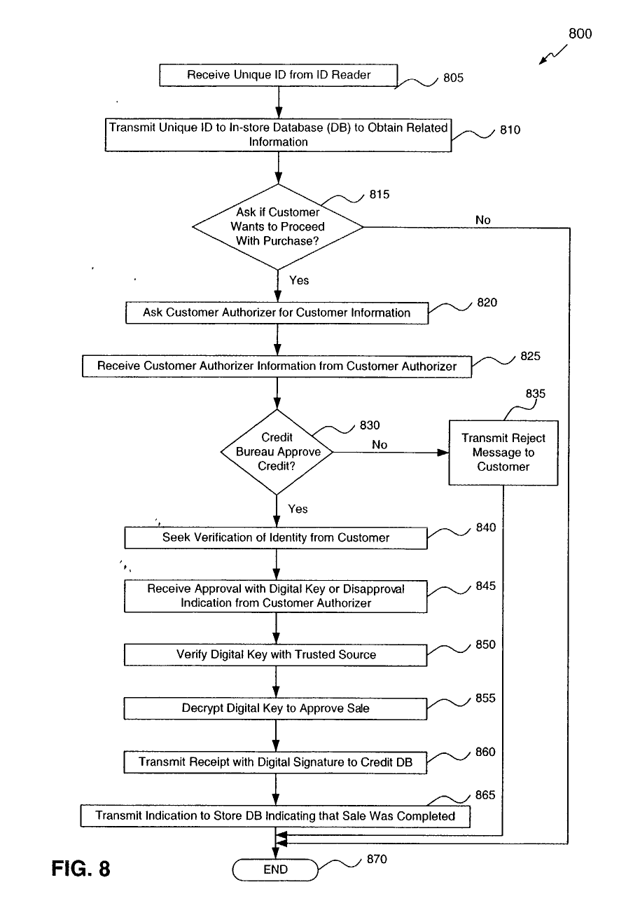

FIG. 8 illustrates cashless and clerkless transaction method 800. The method begins in step 805. In step 805, a customer places a product identification tag, such as tag item 730, of an item that the customer desires to purchase on or near a reader, such as electronic identification reader 725. A point of sale terminal (e.g., point of sale terminal 710) receives the unique product identification from electronic identification reader 725. In step 810, point of sale terminal 710 transmits the unique product identification code to a product description database (e.g., product description database 735) to obtain product description and pricing information. In step 815, the product information is provided to the customer and the customer is asked whether he or she wants to purchase the item. If the customer does not want to purchase the item, the method ends in step 870. If the customer does want to purchase the item, the method proceeds to step 820.

In step 820, point of sale terminal 710 asks a wireless transceiver biometric device (e.g., wireless transceiver biometric device 715) to gather customer information. Wireless transceiver biometric device 715 proceeds to gather personal identification code information, such as a password or credit card number, from the customer. In step 825, point of sale terminal 710 receives the personal identification code information gathered by wireless transceiver biometric device 715.

In step 830, point of sale terminal 710 sends a query to a credit card and billing information database, such as credit card and billing information database 760, to determine whether the customer has appropriate funds or credit to purchase the item. If the customer does not have appropriate funds or credit, the method proceeds to step 835. Instep 835, point of sale terminal 710 transmits a reject message to the customer and the method ends in step 870. If the customer does have appropriate funds or credit, the method proceeds to step 840.

In step 840, point of sale terminal 710 seeks verification of the identity of the customer. Point of sale terminal 710 requests that the customer place a biometric object (e.g., a finger) on or near a scanner (e.g., scanner 705) or wireless transceiver biometric device 715, so that a biometric print may be captured. Point of sale terminal 710 receives a biometric print or a portion of a biometric print from scanner 705 or wireless transceiver biometric device 715. Point of sale terminal 710 then provides the biometric information to a biometric database, such as biometric database 770, for authorization. Biometric database 770 compares the customer print to stored prints to confirm the identity of the customer. In step 845, point of sale terminal 710 receives approval with digital key encryption or disapproval indication. Instep 850, point of sale terminal 710 verifies the digital key with the trusted source for the digital key. In step 855, point of sale terminal 710 decrypts the digital key to approve the sale, provided that the customer's identity was confirmed. In step 860, point of sale terminal 710 transmits a receipt to credit card and billing information database 760. In step 865, point of sale terminal 710 transmits an indication to an inventory database (e.g., inventory database 640) indicating that the sale was completed. In step 870, the method ends.

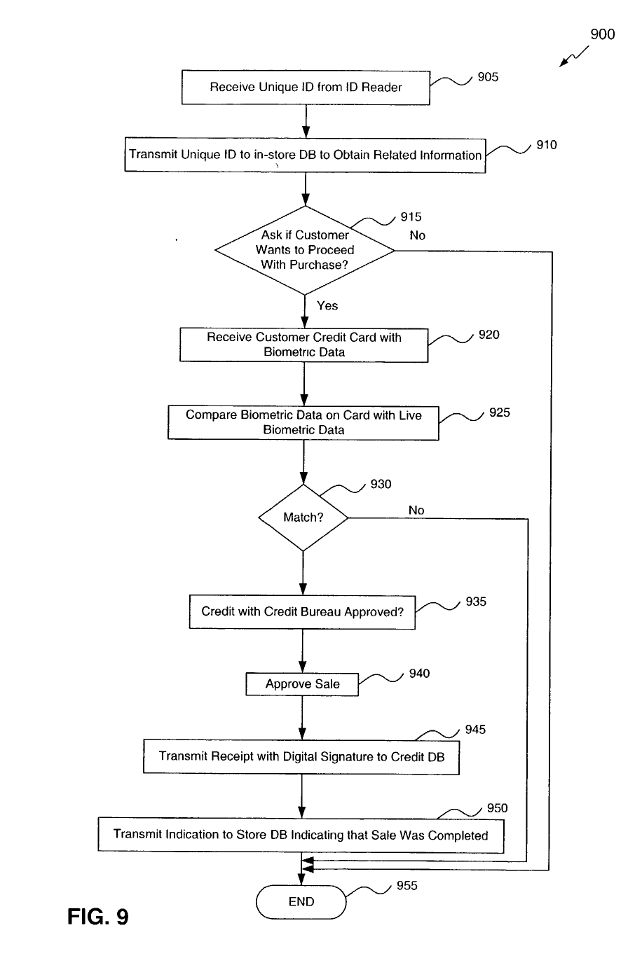

FIG. 9 illustrates cashless and clerkless transaction method 900 using a credit or smart card with stored biometric information. The method begins by obtaining product information in the same way as method 800. In step 905, a customer places the product identification tag, such as tag item 730, of an item that the customer desires to purchase on or near a reader (e.g., electronic identification reader 725). Point of sale terminal 710 receives the unique product identification from electronic identification reader 725. In step 910, point of sale terminal 710 transmits the unique product identification code to a product description database, such as product description database 735, to obtain product description and pricing information. In step 915, the product information is provided to the customer and the customer is asked whether he or she wants to purchase the item. If the customer does not want to purchase the item, the method ends in step 955. If the customer does want to purchase the item, the method proceeds to step 920.

In step 920 point of sale terminal 710 receives customer credit card information that contains traditional credit card information, such as the credit card number, but also includes biometric data for the individual that was stored on the credit card. In step 925, point of sale terminal 710 requests that the customer place a biometric object (e.g., a finger) corresponding to the biometric data stored on the credit card, on or near a scanner (e.g., scanner 705) or a wireless transceiver biometric device (e.g., wireless transceiver biometric device 715), so that a biometric print may be captured. Point of sale terminal 710 receives a biometric print or a portion of a biometric print from scanner 705 or wireless transceiver biometric device 715. Point of sale terminal 710 then compares the live biometric data that was just captured with the biometric data received from the credit card.

In step 930, point of sale terminal 710 determines whether the live biometric data matches the biometric data stored on the individual's credit card. If the data does not match, point of sale terminal 710 will not permit the sales transaction and the process will be terminated instep 955. If the data does match, point of sale terminal 710 proceeds to step 935. In step 935, point of sale terminal 710 sends a query to a credit card and billing information database, such as credit card and billing information database 660, to determine whether the customer has appropriate funds or credit to purchase the item. In step 940, point of sale terminal 710 receives credit authorization information. If the customer does not have appropriate funds or credit, the transaction is not permitted and the method terminates in step 955. If the customer does have appropriate funds or credit, the sale will be approved and the method proceeds to step 945. In step 945, point of sale terminal 710 transmits a receipt to credit card and billing information database 760. In step 950, point of sale terminal 710 transmits an indication to an inventory database (e.g., inventory database 740) indicating that the sale was completed. In step 955 method 900 ends.

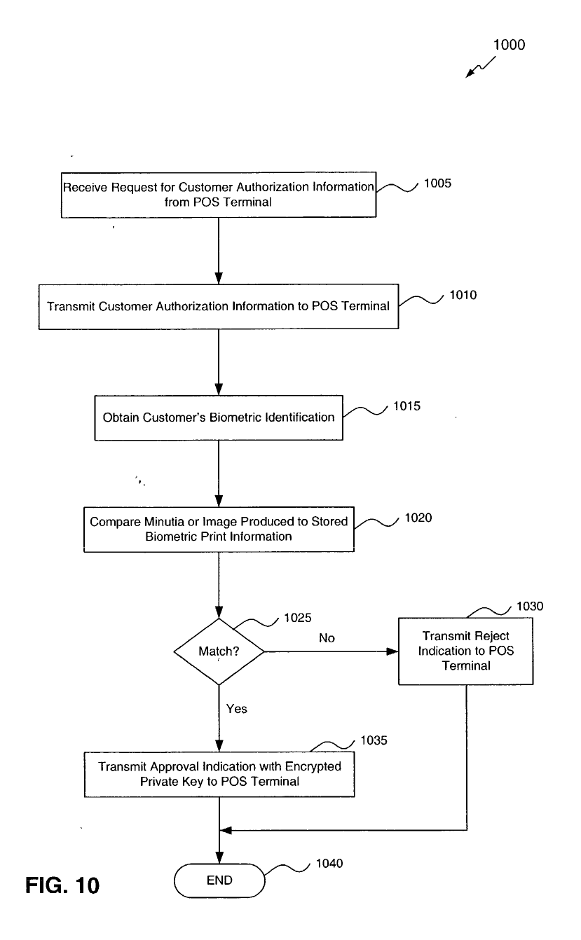

FIG. 10 illustrates customer authentication method 1000. Customer authentication method 1000 highlights the authentication steps included in the cashless and clerkless transaction methods contained in FIGS. 8 and 9. Customer authentication method 1000 begins in step 1005. In step 1005, a personal identification device receives a request from a point of sale terminal, such as point of sale terminal 710, to gather personal identification codes from a customer. In step 1010, customer authorization information is transmitted to point of sale terminal 710. In step 1015, a customer's biometric information is obtained.

In step 1020, the live biometric information captured from the customer is compared to stored prints to authenticate the individual. This comparison may take place in point of sale terminal 710, in an identification device, in biometric database 770 or in some other system. In step 1025, a determination is made whether the live biometric information that was captured in real time from the customer matches stored biometric information for the customer. If the live and stored biometric prints do not match, in step 1030 a rejection indication will be provided and the sales process terminated in step 1040. If a determination is made that the live and stored prints match, in step 1035 the sale will be approved and sales approval information transmitted to the appropriate databases. In step 1040, method 1000 ends.

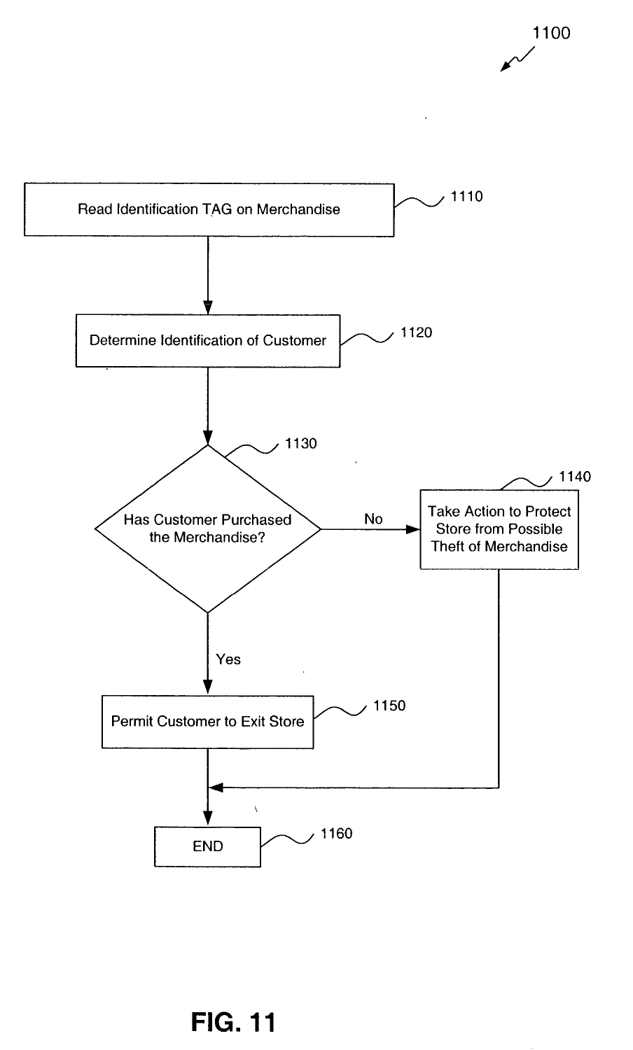

A personal identification device may also be used to confirm that a customer has purchased merchandise that the customer is carrying as the customer exits the store. FIG. 11 illustrates merchandise purchase confirmation method 1100. Merchandise purchase confirmation method 1100 begins in step 1110. In step 1110, an identification tag, such as tag item 730, is read as a customer, who is carrying the merchandise, attempts to leave a store. The identification tag may be read by an electronic identification reader, such as electronic identification reader 725, or may be read by some other type of reader, such as a radio frequency (RF)-type reader.

In step 1120, the identification of the customer is determined. In one embodiment, biometric information about the customer can be captured from an identification device, such as a piezoelectric identification device, a wireless transceiver biometric device (e.g., wireless biometric device 715) or some other means. The captured biometric information is compared to stored biometric information to verify the customer's identity. In step 1130, a determination is made whether the customer purchased the merchandise that the customer is carrying. This can be accomplished by reading information contained in an inventory database, or some other means that associates items purchased with a particular customer.

If a determination is made that the customer has not purchased the merchandise, then method 1100 proceeds to step 1140. In step 1140, action is taken to protect the store from the possible theft of the merchandise. These actions may include sounding an alarm, locking a door or gate, taking a photo of the customer and/or creating an incident report within a security system that the store may be operating. Method 1100 then ends in step 1160. If a determination is made that the customer has purchased the merchandise, then method 1100 proceeds to step 1150. In step 1150, the customer is permitted to exit the store. In step 1160, the method ends.

Compatibility Feature

As described above, embodiments of the invention are capable of interacting with other devices as part of a personal area network. The personal identification device of the invention can be implemented to communicate with other devices using any known wireless communications system or protocol, such as BLUETOOTH and/or IEEE 802.11.

Conclusion

While various embodiments of the present invention have been described above, it should be understood that they have been presented by way of example only, and not limitation. It will be understood by those skilled in the art that various changes in form and details can be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A method for conducting a cashless and clerkless transaction, comprising;
a. receiving a request from a customer to purchase a product;
b. capturing biometric data of the customer with a personal identification device;
c. comparing the captured biometric data to stored biometric data to verify the identity of the customer; and
d. if said comparing in step (c) verifies the identity of the customer, completing a sales transaction.

2. The method of claim 1, wherein said capturing step (b) uses a piezoelectric identification device as the personal identification device.

3. The method of claim 1, wherein said capturing step (b) uses a wireless transceiver biometric device as the personal identification device.

4. The method of claim 1, wherein said capturing step (b) captures fingerprint data as the captured biometric data.

5. The method of claim 1, wherein said capturing step (b) captures palmprint data as the captured biometric data.

6. The method of claim 1, wherein said capturing step (b) captures biometric vital signal data as the captured biometric data.

7. A method for conducting a cashless and clerkless transaction, comprising;
a. receiving product information data to identify a product;
b. receiving customer information from a customer;
c. presenting the customer information to a financial database to seek approval of customer financial status;
d. capturing biometric data of the customer with a personal identification device;
e. comparing the captured biometric data to stored biometric data to verify the identity of the customer; and
f. if said comparing in step (e) verifies the identity of the customer, completing a sales transaction.

8. The method of claim 7, wherein said receiving step (a) comprises receiving a product code as the product identification data.

9. The method of claim 7, wherein said receiving step (a) comprises receiving a product price as the product identification data.

10. The method of claim 7, wherein said receiving step (a) comprises receiving a product description as the product identification data.

11. The method of claim 7, wherein said presenting step (c) comprises presenting a customer name as the customer information.

12. The method of claim 7, wherein said presenting step (c) comprises presenting a customer bank account number as the customer information.

13. The method of claim 7, wherein said presenting step (c) comprises presenting a customer social security number as the customer information.

14. The method of claim 7, wherein said capturing step (d) captures fingerprint data as the captured biometric data.

15. The method of claim 7, wherein said capturing step (d) captures palmprint data as the captured biometric data.

16. The method of claim 7, wherein said capturing step (d) captures biometric vital signal data as the captured biometric data.

17. A method for conducting a cashless and clerkless transaction, comprising;
a. receiving a request from a customer to purchase a product;
b. capturing biometric data of the customer with a personal identification device;
c. receiving stored biometric data of the customer;
d. comparing the captured biometric data with the stored biometric data; and
e. if the biometric data received in step (b) matches biometric data received in step (c) completing a sales transaction.

18. The method of claim 17, wherein said capturing step (b) uses a piezoelectric identification device as the personal identification device.

19. The method of claim 17, wherein said capturing step (b) uses a wireless transceiver biometric device as the personal identification device.

20. The method of claim 17, wherein said capturing step (b) captures fingerprint data as the captured biometric data.

21. The method of claim 17, wherein said capturing step (b) captures palmprint data as the captured biometric data.

22. The method of claim 17, wherein said capturing step (b) captures biometric vital signal data as the captured biometric data.

23. The method of claim 17, wherein said receiving step (c) comprises receiving the stored biometric data stored on a credit card.

24. A method for confirming the purchase of merchandise by a customer, comprising;
a. gathering identification information about the merchandise;
b. capturing biometric data of the customer with a personal identification device;
c. using the merchandise identification information and captured biometric data to determine whether the customer has purchased the merchandise;
d. if a determination is made that indicates that the customer did not purchase the merchandise, taking an action to protect a store from a possible theft of the merchandise.

25. The method of claim 24, wherein said capturing step (b) uses a piezoelectric identification device as the personal identification device.

26. The method of claim 24, wherein said capturing step (b) uses a wireless transceiver biometric device as the personal identification device.

27. The method of claim 24, wherein said capturing step (b) captures fingerprint data as the captured biometric data.

28. The method of claim 24, wherein said capturing step (b) captures palmprint data as the captured biometric data.

29. The method of claim 24, wherein said capturing step (b) captures biometric vital signal data as the captured biometric data.

30. A cashless and clerkless transaction system, comprising;
a point of sale terminal;
a personal identification device coupled to said point of sale terminal; said
personal identification device capturing biometric data from a customer, the biometric data being used to verify whether the customer is authorized to perform a cashless and clerkless transaction; and
a product identification device coupled to said point of sale terminal.

31. The cashless and clerkless transaction system of claim 30, wherein said personal identification device is a piezoelectric identification device.

32. The cashless and clerkless transaction system of claim 30, wherein said personal identification device is a wireless transceiver biometric device.

33. A cashless and clerkless transaction system, comprising;
a point of sale terminal; and
an interface for coupling a personal identification device to said point of sale terminal; said personal identification device capturing biometric data from a customer, the biometric data being used to verify whether the customer is authorized to perform a cashless and clerkless transaction.

34. The cashless and clerkless transaction system of claim 33, wherein the personal identification device is a piezoelectric identification device.

35. The cashless and clerkless transaction system of claim 33, wherein the personal identification device is a wireless transceiver biometric device.
